(19) United States
(12) Patent Application Publication
(10) Pub. No.: US 2011/0035382 A1
(43) Pub. Date: Feb. 10, 2011

(54) Associating Information with Media Content

(75) Inventors: Claus Bauer, Beijing (CN); Wenyu Jiang, Beijing (CN)

Correspondence Address: Dolby Laboratories Inc., 100 Potrero Avenue, San Francisco, CA, 94103-4938, US

(73) Assignee: DOLBY LABORATORIES LICENSING CORPORATION, San Francisco, CA (US)

(21) Appl. No.: 12/865,807

(22) PCT Filed: Feb. 4, 2009
(86) PCT No.: PCT/US09/33011

§ 371 Date: Sep. 28, 2010

Related U.S. Application Data
(60) Provisional application No. 61/026,444, filed on Feb. 5, 2008.

(51) Int. Cl. G06F 15/16; G06F 17/30

(52) U.S. Cl. 707/741; 709/231; 707/812; 707/E17.044; 707/E17.002

(57) ABSTRACT

Information is associated with media content. Upon an upload of a portion of the media content, a media fingerprint is derived therefrom. The media fingerprint includes a unique representation of the media content portion, which is derived from a characteristic component of the media content portion. The information is associated with the media content portion based on the derived media fingerprint. Upon streaming the media content portion, the associated information is linked and presented in real time with the media content portion. Upon upload of the media content portion, the media fingerprint may be derived therefrom at upload time or at any time subsequent to upload time and prior to presentation time. The media content may comprise an original instance of content or a derivative instance of the original content.

### RELATED UNITED STATES APPLICATIONS

This application claims benefits, including filing priority, to co-pending Provisional U.S. Patent Application No. 61/026,444 filed on Feb. 5, 2008, by Claus Bauer and Wenyu Jiang, entitled “Associating Information with Media Content,” and assigned to the assignee of the present invention (with Dolby Ref. No. D07048US01), which is incorporated by reference for all purposes as if fully set forth herein.

### TECHNOLOGY

The present invention relates generally to media. More specifically, embodiments of the present invention relate to associating information with media content.

### BACKGROUND

Audio and video media comprise an essentially ubiquitous feature of modern activity. Multimedia content, such as most modern movies, includes more than one kind of medium, such as both its video content and an audio soundtrack. Modern enterprises of virtually every kind and individuals from many walks of life use audio and video media content in a wide variety of both unique and related ways. Entertainment, commerce and advertising, education, instruction and training, computing and networking, broadcast, enterprise and telecommunications, are but a small sample of modern endeavors in which audio and video media content find common use.

Audio media include music, speech and sounds recorded on individual compact disks (CD) or other storage formats, streamed as digital files between server and client computers over networks, or transmitted with analog and digital electromagnetic signals. Examples of video media include movies and other recorded performances, presentations and animations, and portions thereof, sometimes called clips. It has become about as familiar to find users watching movies from Digital Versatile Disks (DVD) playing on laptop computers while commuting as at home on entertainment systems or in theaters. Concerts from popular bands are streamed over the internet and enjoyed by users as audio and/or viewed as well in webcasts of the performance. Extremely portable lightweight, small form factor, low cost players of digital audio files have gained widespread popularity. Cellular phones, now essentially ubiquitous, and personal digital assistants (PDA) and handheld computers all have versatile functionality. Not just telecommunication devices, modern cell phones access the Internet and stream audio and video content therefrom and, it is no longer unusual to find game enthusiasts participating in networked video game play and fans watching sporting events therewith.

As a result of its widespread and growing use, vast quantities of audio and media content exist. Given the sheer quantity and variety of audio and video media content that exist, and the expanding growth of that content over time, an ability to identify content is of value. Media fingerprints comprise a technique for identifying media content.

Media fingerprints are unique identifiers of media content from which they are extracted or generated. The term “fingerprint” is aptly used to refer to the uniqueness of these media content identifiers, in the sense that human beings are uniquely identifiable, e.g., forensically, by their fingerprints. While similar to a signature, media fingerprints perhaps even more intimately and identifiably correspond to the content. Audio and video media may both be identified using media fingerprints that correspond to each medium.

Audio media are identifiable with acoustic fingerprints. An acoustic fingerprint is generated from a particular audio waveform as code that uniquely corresponds thereto. Upon generating an acoustic fingerprint, the corresponding waveform from which the fingerprint was generated may thereafter be identified by reference to its fingerprint. The acoustic fingerprints may be stored, e.g., in a database. Stored acoustic fingerprints may be accessed to identify, categorize or otherwise classify an audio sample to which it is compared. Acoustic fingerprints are thus useful in identifying music or other recorded, streamed or otherwise transmitted audio media being played by a user, managing sound libraries, monitoring broadcasts, network activities and advertising, and identifying video content (such as a movie) from audio content (such as a soundtrack) associated therewith.

The reliability of an acoustic fingerprint relates to the specificity with which it identifiably corresponds with a particular audio waveform. Some audio fingerprints provide identification so accurately that they may be relied upon to identify separate performances of the same music. Moreover, some acoustic fingerprints are based on audio content as it is perceived by the human psychoacoustic system. Such robust audio fingerprints thus allow audio content to be identified after compression, decompression, transcoding and other changes to the content made with perceptually based audio codecs; even codecs that involve lossy compression (and which may thus tend to degrade audio content quality). Analogous to identifying audio media content by comparison with acoustic fingerprints is the ability to identify video media with digital video fingerprints.

Video fingerprints are generated from the video content to which they correspond. A sequence of video information, e.g., a video stream or clip, is accessed and analyzed. Components characteristic of the video sequence are identified and derived therefrom. Characteristic components may include luminance, chrominance, motion descriptors and/or other features that may be perceived by the human psychovisual system. The derived components are compressed into a readily storable and retrievable format.

Video fingerprints are generated using relatively lossy compression techniques, which render the fingerprint data small in comparison to their corresponding video content. Reconstructing original video content from their corresponding video fingerprints is thus typically neither practical nor feasible. As used herein, a video fingerprint thus refers to a relatively low bit rate representation of an original video content file. Storing and accessing the video fingerprints however is thus more efficient and economical

Stored video fingerprints may be accessed for comparison to a sample of a video sequence, which allows accurate identification of the video content in the sequence. Video fingerprints are thus useful for accurately identifying video content for a user as the content is viewed, as well as in authoritatively managing copyrights, and in validating authorized, and detecting unauthorized, versions and instances of content being stored, streamed or otherwise used. As with many acoustic fingerprints moreover, video fingerprints are perceptually encoded. Thus the content of the video sequence may be accurately identified by comparison to video fingerprints after compression, decompression, transcoding and other changes to the content made with perceptually based video codecs; even codecs that involve lossy compression (and which may thus tend to degrade video content quality).

Audio and video media content may be conceptually, commercially or otherwise related in some way to separate and distinct instances of content. The content that is related to the audio and video content which may include, but is not limited to other audio, video or multimedia content. For instance, a certain song may relate to a particular movie in some conceptual way. Other example may be text files or a computer graphics that relate to a given speech, lecture or musical piece in some commercial context. However, it may not be easy to ascertain the existence of some content that may be related to particular media content, much less to access the related content in association with the media content.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF SUMMARY OF SOME ASPECTS OF AN EXAMPLE EMBODIMENT

The following paragraph presents a brief, simplified summary for providing a basic understanding of some aspects of an embodiment of the present invention. It should be noted that this summary is not an extensive overview of aspects of the embodiment. Moreover, it should be noted that this summary is not intended to be understood as identifying any particularly significant aspects or elements of the embodiment, nor as delineating any scope of the embodiment in particular, nor the invention in general. The following brief summary merely presents some concepts that relate to the example embodiment in a condensed and simplified format, and should be understood as merely a conceptual prelude to a more detailed description of example embodiments that follows the summary.

Information is associated with media content. Upon an upload of a portion of the media content, a media fingerprint is derived therefrom. The media fingerprint comprises a unique representation of the media content portion, which is derived from a characteristic component of the media content portion. The information is associated with the media content portion based on the derived media fingerprint. Upon streaming the media content portion, the associated information is linked and presented with the media content portion. Upon upload of the media content portion, the media fingerprint may be derived therefrom at upload time or at any time subsequent to upload time and prior to presentation (e.g., run out) time. The media content may comprise an original instance of content or a derivative instance of the original content.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 depicts a flowchart for an example procedure, according to an embodiment of the present invention;

FIG. 2 depicts an example system, according to an embodiment of the present invention;

FIG. 3 depicts a flowchart for an example method, according to an embodiment of the present invention;

FIG. 4 depicts a flowchart for another example procedure, according to an embodiment of the present invention;

FIG. 5 depicts an example computer system platform, with which an embodiment of the present invention may be implemented;

FIG. 6 depicts a flowchart for yet another example procedure, according to an embodiment of the present invention; and

FIG. 7 depicts another example system, according to an embodiment of the present invention.

### DESCRIPTION OF EXAMPLE EMBODIMENTS

Associating information with media content is described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

### OVERVIEW

Example embodiments described herein relate to associating information with media content. A media fingerprint is derived from a portion of media content. Information is associated with the media content portion based on the derived media fingerprint. Upon linking to the associated information, the associated information content is presented with the media content portion. As used herein, the terms “associated information,” “associated information content,” and “associated content” may be essentially used synonymously, and the terms “auxiliary information,” “auxiliary associated information,” and “auxiliary content” may refer essentially to the associated information.

As used herein, the term “medium” (plural: “media”) may refer to a storage or transfer container for data and other information. As used herein, the term “multimedia” may refer to media which contain information in multiple forms. Multimedia information files may, for instance, contain audio, video, image, graphical, text, animated and/or other information, and various combinations thereof. As used herein, the term “associated information” may refer to information that relates in some way to information media content. Associated information may comprise, for instance, auxiliary content.

As used herein, the term “media fingerprint” may refer to a representation of a media content file, which is derived from characteristic components thereof. Media fingerprints are derived (e.g., extracted, generated, etc.) from the media content to which they correspond. As used herein, the term “acoustic fingerprint” may refer to a media fingerprint that may be associated with audio media with some degree of particularity (although an acoustic fingerprint may also be associated with other media, as well). As used herein, the term “video fingerprint” may refer to a media fingerprint associated with video media with some degree of particularity (although a video fingerprint may also be associated with other media, as well). Media fingerprints used in embodiments herein may correspond to audio, video, image, graphical, text, animated and/or other media information content, and/or to various combinations thereof, and may refer to other media in addition to media to which they may be associated with some degree of particularity.

Media fingerprints, as described herein, may conform essentially to media fingerprints as described in co-pending Provisional U.S. Patent Application No. 60/930,905 filed on May 17, 2007, by Ragunathan Radhakhrishnan and Claus Bauer, entitled “Video Fingerprint Comparison Resilient to Frame Rate Conversion” and assigned to the assignee of the present invention, which is appended hereto as Appendix ‘B’ and incorporated herein by reference for all purposes as if fully set forth herein.

Media fingerprints, as described herein, may conform essentially to media fingerprints as described in Provisional U.S. Patent Application No. 60/997,943 filed on Oct. 5, 2007, by Ragunathan Radhakhrishnan and Claus Bauer, entitled “Media Fingerprints that Reliably Correspond to Media Content” and assigned to the assignee of the present invention, which is incorporated herein by reference for all purposes as if fully set forth herein.

An acoustic fingerprint, for example, may comprise unique code that is generated from an audio waveform, which comprises the audio media content, using a digital signal processing technique. Also for example, a video fingerprint may comprise a unique digital video file, the components of which are derived (e.g., generated, written, extracted, and/or compressed from characteristic components of video content. Derived characteristic components of video content that may be compressed to form a video fingerprint corresponding thereto may include, but are not limited to, luminance values, chrominance values, motion estimation, prediction and compensation values, and the like. Thus, while media fingerprints described herein represent the media content from which they are derived, they do not comprise and (e.g., for the purposes and in the context of the description herein) are not to be confused with metadata or other tags that may be associated with (e.g., added to or with) the media content. Media fingerprints may be transmissible with lower bit rates than the media content from which they are derived. Importantly, as used herein, the terms “deriving,” “generating,” “writing,” “extracting,” and “compressing,” and the like may thus relate to obtaining media fingerprints from media content portions. These and similar terms may thus relate to a relationship of media fingerprints to source media content thereof or associated therewith. In an embodiment, media content portions are sources of media fingerprints and media fingerprints essentially comprise unique components of the media content. For instance, video fingerprints may be derived from (e.g., comprise at least in part) values relating to chrominance and/or luminance in frames of video content. The video fingerprint may also (or alternatively) comprise values relating to motion estimation, prediction or compensation in video frames, such as motion vectors and similar motion related descriptors. Media fingerprints may thus function to uniquely represent, identify, reference or refer to the media content portions from which they are derived. Concomitantly, these and similar terms herein may be understood to emphasize that media fingerprints are distinct from meta data, tags and other descriptors, which may be added to content for labeling or description purposes and subsequently extracted therefrom. In contexts relating to derivative media content, the terms “derivative” or “derive” may further relate to media content that may represent or comprise other than an original instance of media content.

As used herein, the term “auxiliary content,” in relation to a multimedia or other media content file may refer to a piece of information that is indexed by a certain part of the media content file. The auxiliary information itself may not necessarily be identical, or even approximate, to any part of the multimedia itself. For example, a certain portion of a particular video file may indexes the temperature in a certain location, e.g., New York City, at a certain day or time. The New York City temperature is thus auxiliary content to that part of the video. In another example, a certain portion of a given video file may index a certain model and manufacturing year of a certain model of a particular car manufacturer.

Indexing may be done when an original media file, e.g., a whole movie, is created. However, an embodiment provides a mechanism that enables the linking of a segment of video to auxiliary content during its presentation, e.g., upon a movie playback. An embodiment functions where only parts of a multimedia file are played back, presented on different sets of devices, in different lengths and formats, and/or after various modifications of the video file. Modifications may include, but are not limited to, editing, scaling, transcoding, and creating derivative works thereof, e.g., insertion of the part into other media.

As used herein, the terms “link,” “linked,” “linking” and the like may refer to storing one or more pointers to auxiliary content in a repository such as a database or list of media fingerprints, storing one or more universal resource locators (URL) of one or more locations that contain auxiliary content in a repository such as a database or list of media fingerprints, storing one or more database references that contain auxiliary content in a repository such as a database or list of media fingerprints, or the like. As used herein, the term “links” may refer to retrieving auxiliary content from one or more pointers stored in a repository such as a database or list of media fingerprints, retrieving auxiliary content from one or more files referred to by a repository such as a database or list of media fingerprints retrieving auxiliary content using one or more URLs stored in a repository such as a database or list of media fingerprints, retrieving auxiliary content from one or more database references stored in a repository such as a database or list of media fingerprints, or the like.

An embodiment allows identification of auxiliary content that was assigned to a specific part of a media file when the whole media product was created, even when the file is played back in parts, sequences, and modified forms. Moreover, an embodiment functions without metadata and thus does not require the insertion generation or other operations with metadata related to the content or any modification of the content. Embodiments function with media of virtually any type, including video and audio files and multimedia playback of audio and video files and the like.

Information such as auxiliary content is associated with media content. In an embodiment, media fingerprints such as audio and video fingerprints are used for identifying media content portions. Media fingerprinting identifies not only the whole media work, but also the exact part of the media being presented, e.g., currently being played.

In an embodiment, a database of media fingerprints of media files is maintained. Another database maps specific media fingerprints, which represent specific portions of certain media content, to associated auxiliary content. The auxiliary content may be assigned to the specific media content portion when the media content is created. Upon the media content portion's presentation, a media fingerprint corresponding to the part being presented is compared to the media fingerprints in the mapping database. The comparison may be performed essentially in real time, with respect to presenting the media content portion.

For example, a part of a movie may be played on a video related webpage. A media fingerprint corresponding to the part being played is derived therefrom essentially in real time. The media fingerprint is compared to the fingerprints in the mapping database. Upon identification, e.g., to which part of any movies in the mapping database the part being played back belongs, auxiliary content originally or otherwise assigned to this part of a movie is identified and linked to or retrieved.

An embodiment allows an advertiser to “purchase,” in a sense, a scene of a video. A vendor or an agent thereof (such as a search engine or a web services provider) may thus choose to associate an advertisement for a product, service or the like with a certain media content portion. For example, a soft drink company could identify a scene where an actor is drinking a specific product of their company. The soft drink company or its agent may purchase rights to use the media fingerprint corresponding to that scene to associate their advertisement with that particular media content portion. Thus, upon presenting that scene to a viewer, information associated with that media content portion is linked to and the soft drink company's advertisement is presented, essentially in real time with respect to the scene playing.

The advertising content may be presented next to, proximate to, or overlaid on the video scene. Whenever this specific part of the movie is presented on virtually any media presentation device connected to the Internet or another network facilitating the embodiment, the part of the movie is identified using the media fingerprint technology. Thus, the purchaser and the associated information play-back webpage are informed. Depending on an exchange agreement between the purchaser and the media content provider or other entity presenting the media content, a related advertisement, defined by the purchaser, is shown in real time with or after the corresponding media content portion is presented.

Moreover, an embodiment presents the auxiliary information or other associated information faithfully when the corresponding media content portion is presented, even if the corresponding media content portion is used in derivative content, such as a trailer, an advertisement, or even an unauthorized copy of the media content, pirated for example, for display on a social networking site. In whatever format the media content portion is presented, it is recognized and linked to information associated therewith, such as the auxiliary content. In an embodiment, a portion of media content is used in a search query.

In an embodiment, a computer system performs one or more features described above. The computer system includes one or more processors and may function with hardware, software, firmware and/or any combination thereof to execute one or more of the features described above. The processor(s) and/or other components of the computer system may function, in executing one or more of the features described above, under the direction of computer-readable and executable instructions, which may be encoded in one or multiple computer-readable storage media and/or received by the computer system.

In an embodiment, one or more of the features described above execute in a decoder, which may include hardware, software, firmware and/or any combination thereof, which functions on a computer platform. The computer platform may be disposed with or deployed as a component of an electronic device such as a TV, a DVD player, a gaming device, a workstation, desktop, laptop, hand-held or other computer, a network capable communication device such as a cellular telephone, portable digital assistant (PDA), a portable gaming device, or the like. One or more of the features described above may be implemented with an integrated circuit (IC) device, configured for executing the features. The IC may be an application specific IC (ASIC) and/or a programmable IC device such as a field programmable gate array (FPGA) or a microcontroller.

Embodiments of the present invention associate information with media content with a variety of implementations. Embodiments of the present invention associate information with media content upon uploading existing media content. For example, when existing video content is uploaded to an entity such as YouTube™, which stores and allows access to uploaded media content, media fingerprints are derived from the media content as the content is uploaded into a YouTube file. Media fingerprints may be derived from media content at upload time or at any time following upload and before presentation (e.g., run out) time.

Upon extraction from the associated content, the media fingerprints are matched against a fingerprint database. Where a match is found, fingerprints over the entire content being uploaded are derived. Matching the fingerprints with the fingerprint database identifies each part of the content that gets uploaded. Metadata are created, which characterize the uploaded media file in terms of associated information content, which may be auxiliary content such as advertisements and/or educational material. Importantly, the fingerprint matching may identify exact times within the content runtime at which any auxiliary content is associated with the uploaded multimedia content.

An information file is created and associated with the multimedia content. For an example movie, being uploaded to an entity such as YouTube, the filename would be an identifier given by the entity to the uploaded file. File entries include a first column that contains timestamps from zero (0) to “movie_length.” The first column timestamps index a second column, which contains references to information such as auxiliary content (e.g., advertisements, educational material) that is associated with the timestamps. When the movie is streamed, the information file is scanned by the entity in parallel with the movie streaming. The entity then displays the auxiliary content, as directed by entries in the second column.

Extracting media fingerprints from media content upon upload (e.g., at upload time or subsequent thereto but prior to play-out time) allows association of information such as presentation of auxiliary information prior to play-out time. This deters gaps in association of information with media content. In as much as gaps in associating information with media content may correspond to missed opportunities for presentation of auxiliary information therewith, deterring formation of such gaps can increase advertising revenues, educational efficiency and realize other benefits of associating auxiliary information with multimedia content.

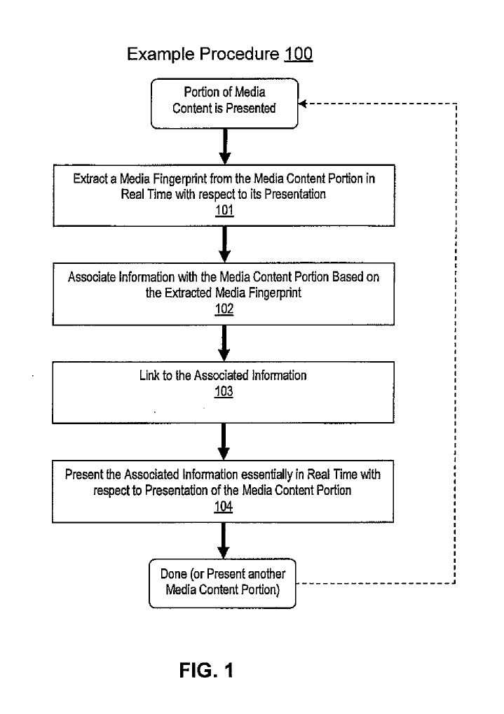

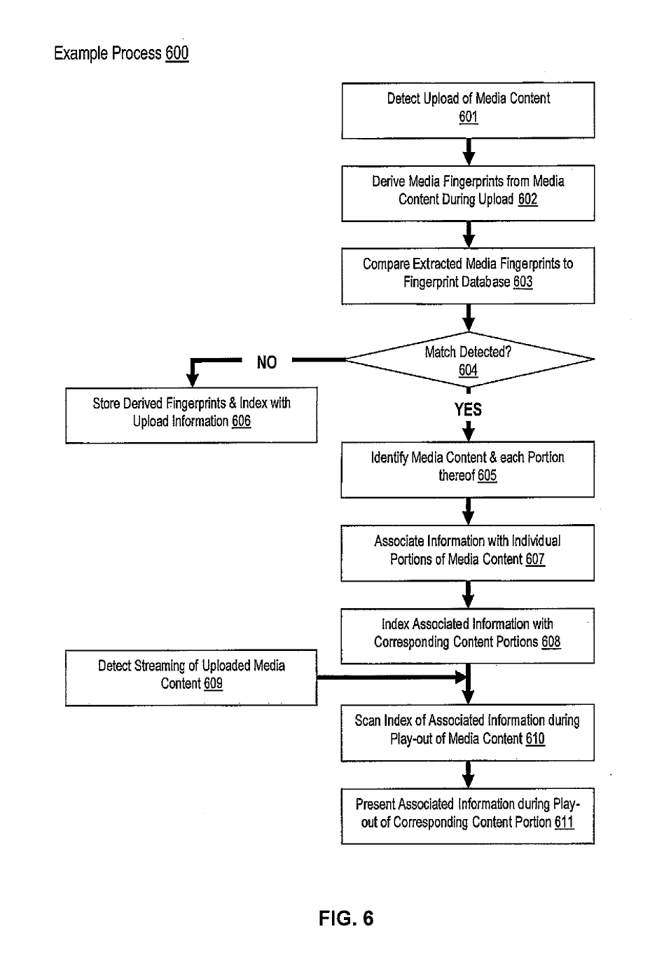

An example embodiment that associates information with media content with media fingerprint extraction upon uploading the content is described commencing with Section II at FIG. 6 herein. Presented first, Section I with FIGS. 1-5 describes of an example of associating information with a media content portion, with media extraction at play-out time, to provide context for and to, and additional material relating to the description of associating information with media content, with media fingerprint extraction upon upload of the content.

### SECTION I

### Associating Information with a Portion of Media Content

Example Procedures

The example procedures and methods described herein may be performed in relation to associating information with a portion of media content. Procedures that may be implemented with an embodiment may be performed with more or less steps than the example steps shown and/or with steps executing in an order that may differ from that of the example procedures. The example procedures may execute on one or more computer systems, e.g., under the control of machine readable instructions encoded in one or more computer readable storage media, or the procedure may execute in an ASIC or programmable IC device.

FIG. 1 depicts a flowchart for an example procedure 100, according to an embodiment of the present invention. Procedure 100 relates to associating information with a portion of media content. Initially, the portion of media content, such as a song or a part of a song on an album or other collection of songs, or a certain part of movie, is presented. For example, the media portion is presented as a user is listening to the song or viewing the movie in a video format.

In step 101, a media fingerprint is derived from the media content portion, essentially in real time with respect to the presentation of the media content portion. The media content portion may have a particular temporal length (e.g., of a certain time duration, a given number of film or video frames, etc.). In an implementation for instance, a media content portion may comprise a six second long segments of a video. The media fingerprint may be an acoustic fingerprint for audio media or a video fingerprint for video media. In some cases, an acoustic fingerprint may be derived from a portion of video media content and vice versa; a video fingerprint may be derived from a portion of audio content. The media fingerprint may be derived from other media, such as image, graphical, text, and animation related media, as well as from audio and video media. In some cases, more than one media fingerprint may be derived from a portion of multimedia content.

Prior to extracting the media fingerprint from the media content portion, other functions may occur. For instance, the media content portion being presented, from which the media fingerprint is to be derived, is accessed.

In step 102, information content is associated with the media content portion based on the derived media fingerprint. The information content may be auxiliary or ancillary information that relates in some conceptual or commercial way with the media content portion. The information content may be indexed to the media content portion, for instance, upon creation of the original media content of which the portion comprises a component. The information content may be stored in a repository such as a database, may include video, audio, textual, graphical, haptic or other content, and may include commercial, advertising, instructional, informative or other content associated with the media content portion. For clarity, the term “auxiliary information” may be used hereinafter in referring to the information associated with a media content portion.

In step 103, a link is made to the associated information. Prior to associating the information with the media content portion and linking to the associated information, other functions may occur. For instance, the derived media fingerprint may be compared to a repository such as a database of multiple stored media fingerprints, matched thereto and thus identified. Associating the information and linking thereto may be based on the comparison, match and corresponding identification of the media fingerprint.

In step 104, the information that is associated with the media content portion is presented therewith. For instance, the associated information may be presented essentially in real time with respect to the presentation of the media content portion. The associated information may be presented in conjunction with the media content portion, for example, in a display field adjacent (or otherwise proximate) to a display field in which the media content portion is presented, or overlaid, superimposed, or inset with respect thereto.

Thus for example, a hypothetical movie (e.g., media content) contains a scene (e.g., content portion) in which a star actor enters and drives a certain make and model sports car, or drinks from a particular brand of beverage. Auxiliary information may be associated with this scene that may include an advertisement for the certain make and model sports car or the beverage. As the scene plays, a link to the advertisement is provided. The media player, with which the scene is presented, thus links to the advertisement and presents the advertisement during the scene, in a display field proximate to the display field in which the scene is playing, or may superimpose the advertisement content over the scene, perhaps consciously apparent to a viewer or perhaps presented thereto subliminally.

In addition to advertisements, the auxiliary information associated with the media content may include other commercial information. For example, a hypothetical training video (e.g., media content) for engineers, mechanics, physicians, or technicians may include a segment (e.g., content portion) in which an instructor, a teacher, professor or narrator demonstrates the function of a certain instrument, device, apparatus, component, chemical, solution, tool or the like. Auxiliary information may be associated with this segment that may include commercial information related to the instrument, tool, etc.

Moreover, auxiliary information associated with the media content may include content that is informative in some manner or context with respect to the media content portion. For example, a hypothetical movie (e.g., media content) may be a screen adaptation from a work of classic literature, such as William Shakespeare's Titus Andronicus or Johann Wolfgang von Goethe's Faust, or a movie or video that has achieved classic status or other special significance in cinematography, such as Gone with the Wind, Casablanca, or Apocalypse Now. A particular scene (e.g., content portion) of the movie may have some special literary or other artistic merit.

For example, the character Aaron's soliloquy, upon discovering his child in Titus Andronicus may be thought by literati to have special and perhaps enduring literary and dramatic (perhaps even spiritual) significance. During a presentation of a movie adaptation of Titus Andronicus in a hypothetical educational or literary setting, a scene is presented that includes a part of Aaron's famous soliloquy. Auxiliary information content may include a video, audio or text based commentary by a professor of literature, English or drama, or a theatrical critic or commentator that bears upon Aaron's soliloquy, and is thus associated with the scene being presented. Upon associating this auxiliary information with the scene and linking thereto, the commentary may be presented with the scene.

The association with and link to the associated auxiliary information may be made in real time with the presentation of the scene. The presentation of the auxiliary information may be made in real time and proximate to the media content portion as well. To keep from distracting viewers and listeners of so acclaimed a soliloquy with the commentary related thereto however, real time presentation of the auxiliary content associated therewith may include simply a text or graphics based symbol that signifies the availability of the auxiliary information. The symbol that signifies the availability of the auxiliary information may allow the full commentary to be presented in real time, e.g., upon receiving an input. Alternatively, the presentation of the auxiliary content may be delayed and presented, e.g., after the scene is presented, or the scene may be viewed first with only a symbol that the commentary is available and then repeated with the commentary presented contemporaneously therewith.

Media content that have portions to which such informative auxiliary information may be associated are not limited to literary and other artistic works but may sound in virtually any field. For instance, media content may include recordings of scientific symposia, classroom lessons, political campaigns, speeches, debates, town hall meetings, legal and government proceedings, and the like. Auxiliary information that may be associated with media content may thus include also include instructional, educational, aesthetic, contextual, and analytic information. Such auxiliary associated information may include commentary or criticism related to the media content portion. Alternative information may also be associated with the media content portion, for example, in the context of political campaigning. Auxiliary information associated with such media content may thus contrast with or contradict the media content portion, or include comparison thereto and augmentation and substantiation thereof.

Upon presenting the associated information with the media content portion, procedure 100 may continue (or restart) as another media content portion is presented or accessed. Alternatively, procedure 100 may be complete upon presenting the associated information with the media content portion.

The media content portion and its component parts portions may include original media content. A part of a media content portion may also include derivative content. Derivative content may be derived from the media content portion with an item of content that is independent with respect to the original instance of the media content. Derivative content may include a media sequence related to the original media content, such as an audio sample taken from a part of a song or a movie trailer taken from a scene of a video. Derivative content may be an authorized copy of original media content.

For example, song samples and video trailers may be used to respectively advertise music and movies by an enterprise that owns the media and/or is engaged in marketing the media. However, embodiments of the present invention function even with derivative content that are not authorized, such as unauthorized copies of original content that are pirated. Thus, the auxiliary information is associated and linked to even from unauthorized copies of pirated media content portions.

Moreover, the media content and portions thereof may include content that is modified with respect to an original instance (e.g., version, etc.) of the media content. The media content that has been scaled, edited, transcoded, scaled converted, reformatted, or the like, or modified by combinations of such modifications.

Example System

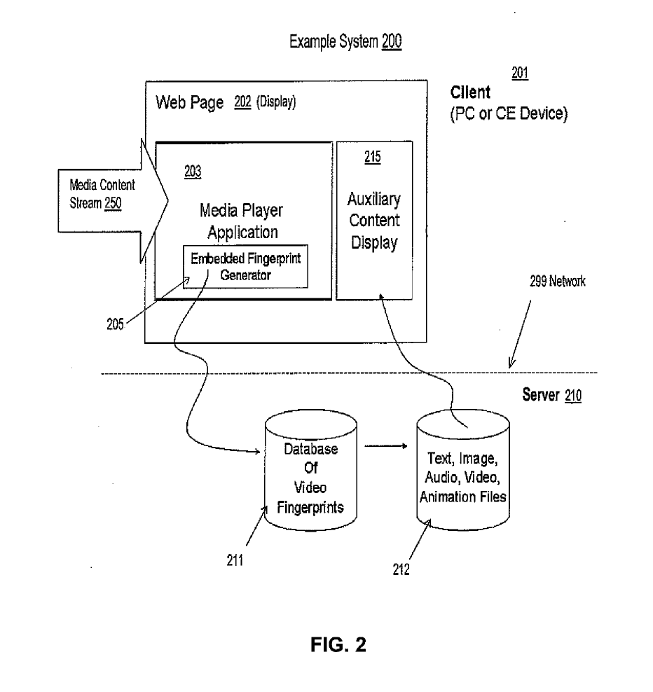

FIG. 2 depicts an example system 200, according to an embodiment of the present invention. System 200 functions in relation to associating information with a portion of media content. System 200 may thus execute a process, perform a procedure, or otherwise function to associate information with a portion of media content. In an embodiment, system 200 performs a procedure for associating information with a portion of media content such as procedure 100, described above with reference to FIG. 1.

A portion of system 200 may be configured with one or more components of a computer system, which may operate under control of instructions that are encoded with computer readable storage media. A portion of system 200 may also be configured with an ASIC or a programmable IC device. Portions of system 200 may be disposed within a network capable media player or decoder and information repositories such as one or more databases. One or more repositories may be disposed integrally with, proximate to, or remote from other components of system 200, including the media player or decoder and/or another repository. Some components of system 200 may be coupled to other components thereof via one or more networks, which may include the Internet.

System 200 has a client computer 201. Client computer 201 may be a workstation, a personal computer (PC), or a consumer electronic (CE) device such as a TV, DVD player, stereo music system, home theater system or the like. Client 201 is communicatively coupled, directly or via one or more networks 299, with one or more servers 210. (Alternatively, one or more of servers 210 may be implemented with another client computer, e.g., another PC or CE device.) One or more of the servers 210 may be an Internet server. One or more of the servers 210 may be a database server.

A stream 250 of media content is accessed (e.g., received, downloaded, or played back from a DVD, CD or other content recording) by client 201. Portions (e.g., six second segments) of the media content of stream 250 are decoded by a media player application 203. Media player application 203 presents the decoded portions on a web page or other presentation capable display 202. Media player application 203 may present the media content portions sequentially with respect to media content stream 250 as a whole, although their presentation may be disjoint with respect to the order with which some of the portions are decoded.

Media player application 201 has an embedded media fingerprint generator (e.g., extractor) 205. Fingerprint generator 205 periodically extracts media fingerprints from media content stream 250. In an embodiment, one or more media fingerprints are derived from media content stream 250 for every portion of the media content therein and in real time with respect to presentation of that portion. In an implementation, media content portions are six second long. However, the media content portions with which media fingerprints correspond may be of virtually any temporal length, which may be measured according to time duration, a number of frames, or the like, and which may be variable from one section of portions of content stream 250 to another.

Upon extraction from the portions of stream 250, each of the media fingerprints is compared to multiple stored media fingerprints in a repository 211 thereof, such as a media fingerprint database. (While video fingerprints are discussed for example, embodiments of the present invention are well suited to function with any kind of media fingerprints.) Fingerprint repository 211 may comprise a data storage component of client 201, a storage component that is proximate to or local with respect to client 201 and/or communicatively coupled thereto essentially directly, or a storage repository remote from client 201 and communicatively coupled therewith via one or more of networks 299.

Matching a media fingerprint derived from a portion of media content stream 250 to one of the media fingerprints stored in media fingerprint repository 211 allows identification of media content stream 250 and the portion thereof from which the matched fingerprint was derived. The identified media content portion is compared to a repository 212 such as a database of information content, including multiple audio, video, image, graphics, text, animation files, and combinations of multiple media files. Repository 212 may comprise a component of repository 211 or may be separate or independent therefrom and proximate to or local with respect to repository 211 or remote therefrom.

Repository 212 may be communicatively coupled essentially directly with repository 211 or communicatively coupled therewith via one or more of networks 299. With respect to one another, repositories 211 and 212 may comprise identical, similar, or different information storage types. Either or both of repositories 211 and 212 may comprise a database, a file system, a storage area network (SAN), network area storage (NAS) or network based virtual storage.

Upon the comparison and finding a match between the identified media fingerprint derived from the portion of stream 250 and information content stored in repository 212, a match may be found. The matching content is associated with the portion of stream 250 as auxiliary information content 215 in relation thereto. Media player application 203 links to the associated auxiliary content 215. Media player application 203 presents the auxiliary content 215 in real time with respect to the presentation of the portion of stream 250 associated therewith. The associated (e.g., auxiliary) content 215 is displayed alongside, over, superimposed on, or otherwise proximate to or in conjunction with the corresponding portion of stream 250 on the web page or other display 202.

Example Methods

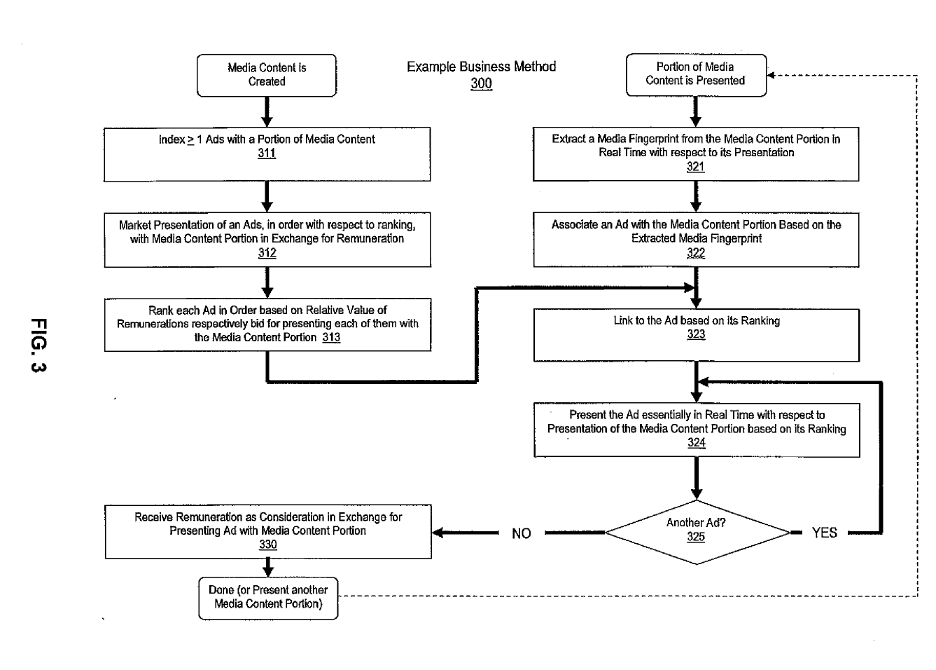

Procedures and systems described herein may be used for conducting business operations such as may relate to sales and presentation of advertising and instruction and the presentation of commercial and educational information. FIG. 3 depicts a flowchart for an example method 300, according to an embodiment of the present invention. Upon creation of media content, one or more advertisements (“Ads”) are indexed in step 311 with a portion thereof.

In step 312, presentation of the advertisements in exchange for valuable consideration such as remuneration, revenue or the like, is marketed with the media content portion. For example, the advertisements may be marketed to entities that may want to associate an advertisement related to their product or service, with the media content portion. Where more than one advertisement is associated with a single media content portion, each of the advertisements may be ranked in an order.

In step 313 therefore, each of the advertisements is ranked in an order that is based on the relative values of the remuneration, which were respectively offered (e.g., bid) for presenting them with the media content portion. For example, a first price value is greater than a second price value. A first advertisement from a first entity, which bids the first price value for associating the first advertisement with the media content portion, is ranked higher in the order than a second advertisement from a second entity, which bid the lower second price value for associating the second advertisement with the media content portion.

Upon presentation of the media content portion, a media fingerprint is derived from the media content portion in step 321. The media fingerprint is derived in real time with respect to the presentation of the corresponding media content portion. In step 322, one or more advertisements are associated with the media content portion, based on the media fingerprint derived therefrom.

In step 323, a link is made to one or more of the advertisements, based on their respective rankings. In step 324, the advertisement to which a link is established is presented essentially in real time with respect to the presentation of the media content portion.

In step 325, it is determined whether another advertisement is associated with the media content portion. If so, step 324 is repeated for the other advertisement. Other advertisements may be selectively or sequentially displayed with the media content portion, based on their respective rankings.

If no other advertisements are associated with the media content portion, or upon presentation of all or a given number of the other advertisements associated therewith, remuneration is received in step 330, e.g., upon notification, billing, debiting, invoicing or the like of the entities that have agreed to have their advertisements presented with the media content. Business method 300 may now be complete or may repeat upon presentation of another media content portion.

Other business methods may relate to providing instruction, education, or training, providing a forum for commentary, or providing commercial information in exchange for remuneration. In these business methods, instructional, educational, or technical information, commentary, concurrence, debate and dissent, and commercial information are respectively associated with media content. Upon presentation of a certain media content portion, a particular item of the associated (e.g., auxiliary) information is provided and remuneration is received in exchange therefore.

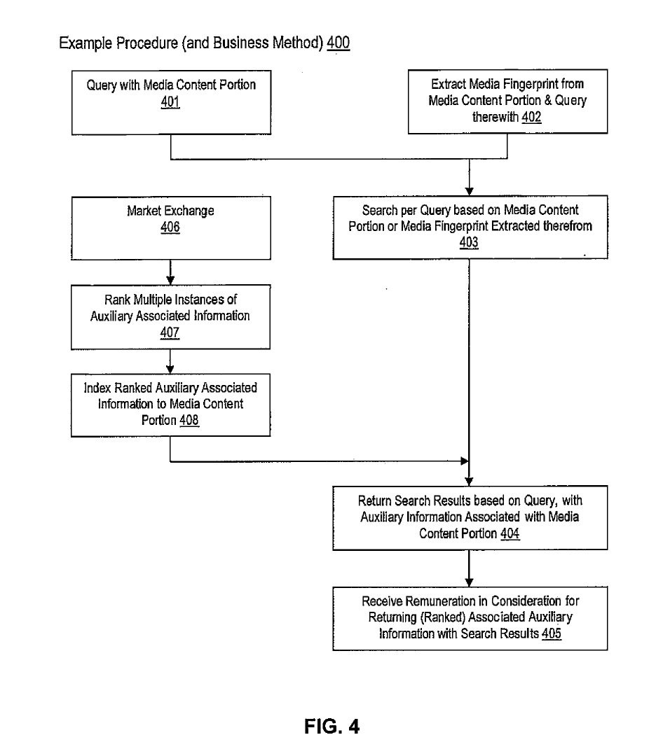

FIG. 4 depicts a flowchart for another example procedure 400, according to an embodiment of the present invention. In step 401, media content or a portion thereof comprises a query input to a search engine. In another embodiment, a media fingerprint is derived in step 402 to form a query input. Querying with a media fingerprint input may conserve bandwidth, e.g., in comparison to using raw media content or a portion thereof, from which the media fingerprint is derived, as a query input. In step 403, a search engine performs a search for information relating to the media fingerprint or the media content or portion thereof. The search may thus be performed based on a media fingerprint derived from the media content or portion. The search may be performed across multiple information repositories such as databases and a virtual database comprising the contents of the Internet. In step 404, auxiliary information associated with the media content portion may be presented with the search results returned in response to the query.

Either of these embodiments may be used for searching libraries, databases, or other repositories of media content for particular media segments or other portions of media content. Upon returning search results in response to queries that include portions of media content or media fingerprints derived therefrom, information that is associated with the media content portion is presented with the search results.

Moreover, another business method may be related to procedure 400. For instance, in step 405, valuable consideration is received in exchange for returning the auxiliary associated information with the search results. The exchange may be marketed in step 406. Multiple instances of auxiliary associated information may exist. In step 407, the multiple instances may be ranked. In an embodiment, the ranking may be based on the value of remuneration agreed to in exchange for linking to and/or providing the auxiliary information with the search results. In step 408, the ranked auxiliary associated information may be indexed to the media content portion and/or search results.

Example Computer System Platform

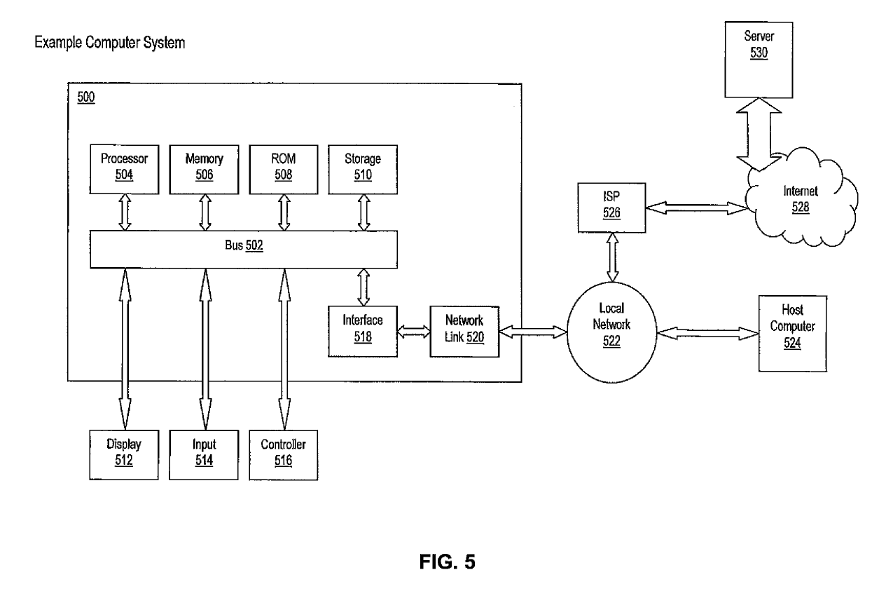

FIG. 5 depicts an example computer system platform 500, with which an embodiment of the present invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), cathode ray tube (CRT) or the like, for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for associating information with media content. According to one embodiment of the invention, associating information with media content is provided by computer system 500 in response to processor 504 executing one or more sequences of one or more instructions contained in main memory 506. Such instructions may be read into main memory 506 from another computer-readable medium, such as storage device 510. Execution of the sequences of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 504 for execution. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and other conductors and fiber optics, including the wires that comprise bus 502. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other legacy or other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the data on the telephone line and use an infrared transmitter to convert the data to an infrared signal. An infrared detector coupled to bus 502 can receive the data carried in the infrared signal and place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card or a digital subscriber line (DSL), cable or other modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are exemplary forms of carrier waves transporting the information.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. In accordance with the invention, one such downloaded application provides for associating information with media content, as described herein.

The received code may be executed by processor 504 as it is received, and/or stored in storage device 510, or other non-volatile storage for later execution. In this manner, computer system 500 may obtain application code in the form of a carrier wave.

### SECTION II

### Associating Information with Media Content

Embodiments of the present invention relate to associating information with media content. Media fingerprints may be derived upon upload (e.g., at upload time or thereafter but prior to play-out time). Embodiments of the present invention may be implemented with a variety of procedures, methods and systems. The description herein in Section I above describes associating information with a portion of media content, with media fingerprints derived at play-out time. Section I above thus represents a discussion that provides context in relation to embodiments of the present invention and describes example systems and computer platforms with which embodiments of the present invention may be practiced, e.g., associating information with media content.

Example Procedure

Media such as video and audio content may be readily accessed from various sources, which include websites and web services. Moreover, various entities operate and maintain websites that allow individuals to upload and store media content, which is then accessible to others. For instance, YouTube™ allows individuals to upload media content which is indexed and stored and made available for streaming to individuals who may desire to access the content.

FIG. 6 depicts a flowchart for an example procedure 600, according to an embodiment of the present invention. In step 601, uploading of media content is detected by a media entity that receives media uploads, stores and indexes the uploaded media content, and makes the media content available for streaming. In step 602, media fingerprints are derived from the media content at upload time, e.g., as the content is uploaded to the entity. Media fingerprints may be derived from media content at upload time or at any time following upload and before presentation (e.g., run out) time. As each portion of the media content uploads, fingerprints are derived in real time from each portion.

In step 603, the derived media fingerprints are compared to a repository of stored media fingerprints such as a fingerprint database. The fingerprints may be compared to the database in real time with respect to their extraction from their respective content portions with essentially no intentional delay upon successful uploading of each portion. In step 604, it is determined whether a match is detected between the derived media fingerprints and the databased fingerprints. If a match is detected, then in step 605, the uploading media content is identified. Each portion of the media content may be individually identified as fingerprints that correspond to each portion are derived therefrom and fingerprints over the entire content are derived over the course of uploading the content.

In step 606, if no match is detected, derived fingerprints may optionally be stored and indexed with information that relates to the upload, e.g., for subsequent analysis and/or identification. Alternatively, derived fingerprints for which no match is found may be deleted, overwritten, or the like. It is also possible that uploaded media content may comprise “original” media content, for which no fingerprints have been indexed. In this case, fingerprinting of the media content and indexing thereof may optionally be performed in relation to the uploaded original content.

In step 607, upon identifying the uploading media on the basis of fingerprints derived therefrom matching databased fingerprints, information may be associated with the media content. The information may be auxiliary information such as an advertisement, educational material or the like (e.g., as described in Section I, above). In as much as each portion of the media content may be individually identified from fingerprints corresponding thereto, information may be associated with each content portion.

In step 608, the information associated with the content portions is indexed thereto. In an embodiment, metadata are created, which characterize the uploaded media file in terms of the associated information content that may correspond to each portion thereof. The metadata are stored in an information file that is associated with the content. Importantly, indexing the information associated with the content portions identifies exact times within the content, e.g., throughout its entire runtime, at which auxiliary content or other information is associated with the uploaded multimedia content.

For example, the media content may comprise a movie that is uploaded to an entity such as YouTube. The information file is created by the upload entity and associated with the example movie and assigned an identifier such as a filename. Entries within the information file include a first column (or other data format) that contains timestamps from time ‘zero’ (0) to a time ‘movie_length’ that corresponds to the duration of the movie. The timestamps thus function to delineate individual content portions. These timestamps index a second column (or other data format), which contain references to the associated information that may correspond to the content portion (e.g., movie interval) delineated with the timestamps of the first column.

After content is uploaded, the upload entity may make the content available for streaming. In step 609, streaming of the uploaded media content is detected. In step 610, the index of information associated with the content is scanned in parallel with play-out of the content. In step 611, the associated information is presented during play-out of the content portions to which they correspond. As the content is streamed, its file of stored information is scanned. As each content portion is reached, timestamps stored in the first column of the file index the second column to identify the appropriate corresponding information associated with that portion. The entity then displays the associated information, as directed by the file entries in the second column. For example, an appropriate advertisement, educational comment or the like, which corresponds to a certain content portion may be presented in real time with the content portion.

An embodiment may use one or methods similar to those described in Section I above in operating business enterprises and other endeavors. For instance, fees may be charged for displaying the advertisements with the appropriate content portions. Advertisements may be selected from among several candidates based on a ranking that may involve fees charged for different advertising rates. Similarly, educational material or the like may be displayed as auxiliary information content, in association with particular content portions.

Extracting media fingerprints from media content upon upload (e.g., at upload time or after upload but prior to play-out time) allows association of information such as presentation of auxiliary information prior to play-out time. This deters gaps in association of information with media content. In as much as gaps in associating information with media content may correspond to missed opportunities for presentation of auxiliary information therewith, deterring formation of such gaps can increase advertising revenues, educational efficiency and realize other benefits of associating auxiliary information with multimedia content.

Example System

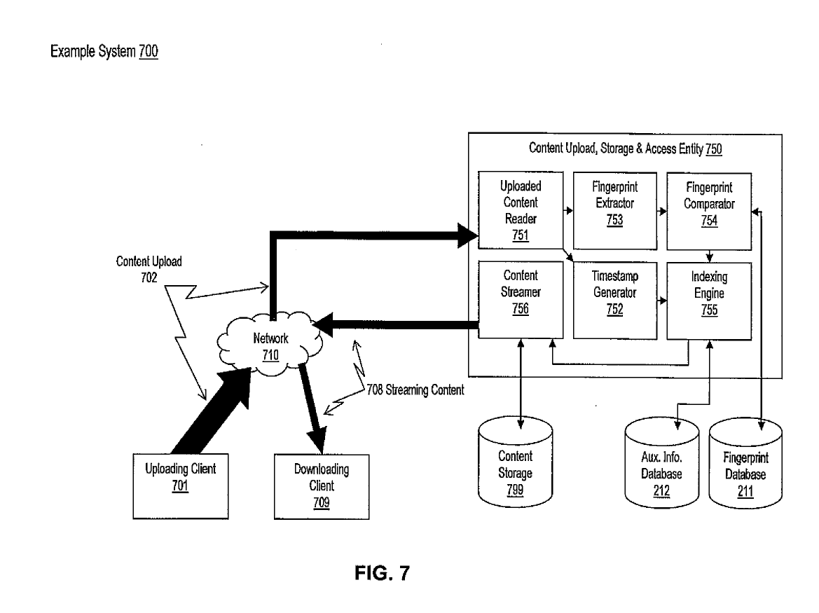

FIG. 7 depicts an example system 700, according to an embodiment of the present invention. System 700 may use or comprise one or more components of at least one computer system, such as computer platform 500 (FIG. 5), described in Section I above. System 700 is well suited for executing procedures for associating information with media content, such as procedure 600 (FIG. 6) above, in which media fingerprints are derived from media content upon upload (e.g., at upload time or after upload but prior to play-out time).

System 700 may be effectuated by a content upload, storage and access entity 750. Entity 750 functions to allow uploading of media content, storing the uploaded content and providing access thereto such as by streaming. Entity 750 may be thought of as representative of functions that are used or performed by network based systems such as may be deployed, operated or maintained any of a variety of enterprises. Such enterprises may include businesses and educational, governmental and social institutions. The enterprises may engage in providing information such as auxiliary content in association with media content as a service, which may be operated as a profit or revenue generating function thereof, similar to or such as described in Section I, above.

For instance, YOUTUBE®, GOOGLE IMAGES™, ITUNES® and other, in a functional sense, substantially somewhat similar web based businesses may allow users to upload media content for storage and access by others. They may, in fact, function to provide the upload, storage and streaming service features available to client computer users at a low or very low cost; perhaps even gratuitously. Upon the stored content being accessed, entity 750 may further function to provide auxiliary content linked to certain content portions and displayed essentially in real time with respect therewith. The media content may, for example, comprise a movie and the auxiliary content may include advertisements, critical or educational commentary or the like. Each unit of auxiliary content may correspond, e.g., temporally as well as subjectively or contextually, to certain portions of the media content. Upon presentation of the auxiliary information, a business entity may assess a fee. Fees may be based on a per instance of advertisement presentation for example, or they may include tuition paid for an on line course that presents timely educational information in real time with respect to the appropriate content portions. In an embodiment, functions of one or more components described herein with respect to entity 750 may be subsumed in the function of another.

Entity 750 is communicatively coupled with data communications network 710. Network 710 may include one or more networks, which may include the Internet. Client computers 701 and 709 are also communicatively coupled with network 710. Client 701 uploads content 702 to entity 750 via network 710. Entity 750 streams content 708 to client 709.

Upon receiving content upload 702, the content is processed with uploaded content reader 751. Upon upload (e.g., at upload time or after upload but prior to play-out time), fingerprint extractor 753 extracts media fingerprints from the processed content. Fingerprint comparator 754 compares the derived fingerprints against those stored in fingerprint database 711 and, on the basis of matches detected between the derived fingerprints and databased fingerprints, identifies the uploaded content. Indexing engine 755 formats a data configuration such as a file, which identifiably corresponds to the media content.

For example, index engine 755 may open a file and assign a file name to the identified uploaded media content. Index engine 755 writes information such as metadata to the file, which is descriptive of the media content. The metadata include temporal data such as timestamps, with which individual component portions of the media content may be identified or described. In an embodiment, timestamp generator 752 writes portion descriptive temporal metadata to a column of the media content file.

Index engine 755 correlates each media content portion with associated information stored in auxiliary information (“aux. info.”) database 712. For example, index engine 755 may index metadata, descriptive of stored units of auxiliary information and stored in an associated information column of the content file, to the timestamps that are written in the temporal metadata column, which correspond to the individual content portions.

Content storage 799 stores uploaded (and pre-stored) media content. Content storage 799, auxiliary information database 712 and/or fingerprint database 711 may comprise functions of a single or multiple storage repositories. Alternatively, the repositories may be physically or logically disposed in multiple databases, which may be networked, mirrored, clustered and/or redundant, and may include SAN or NAS components. The repositories may be components of entity 750, or they may be communicatively coupled therewith and disposed proximate thereto or remote therefrom. Functions of one or more of databases 711 and 712 may respectively substantially duplicate, mimic, mirror or represent analogous functions that may be performed by databases 211 and 212 (FIG. 2), as described in Section I, above.

Upon a request from client 709, entity 750 streams previously uploaded (or pre-stored) content 708 to client 709 via network 710. Content streamer 756 streamer retrieves the content from content storage 799. Content streamer 799 functions with indexing engine 755 to identify the datafile that corresponds to the requested content with its filename. While streaming content 708, content streamer 756 scans the datafile. Content streamer 756 functions with indexing engine 755 to retrieve instances of associated information from auxiliary information database 212 with the portions of media content to which they correspond. The associated information is thus provided in real time with the media content portions to which they correspond.

Example Method

Example embodiments of the present invention may relate to one or more of the method descriptions that are enumerated in the paragraphs below.

1. A method for associating information with media content, comprising the steps of:

upon an upload of a portion of the media content, deriving a media fingerprint from the portion of the media content wherein the media fingerprint comprises a unique representation of the media content portion that is derived from a characteristic component of the media content portion;

associating information with the media content portion based on the derived media fingerprint;

streaming the media content portion; and

linking to the associated information in real time with respect to one or more of the associating or streaming steps;

wherein the associated content is automatically presented in real time with the portion of media content.

2. The method as recited in enumerated example embodiment 1, further comprising the step of storing the uploaded media content portion.

3. The method as recited in enumerated example embodiment 2, further comprising the step of characterizing the media content portion.

4. The method as recited in enumerated example embodiment 3 wherein the characterizing step comprises the steps of:

generating metadata that describes the media content portion; and

storing the metadata in association with the media content portion.

5. The method as recited in enumerated example embodiment 3 wherein the characterizing step comprises the step of identifying the media content portion in relation to a temporal aspect relating to the media content to which the portion belongs.

6. The method as recited in enumerated example embodiment 5 wherein the temporal aspect relates to a time period to which the media content portion corresponds within the duration of the media content to which the portion belongs.

7. The method as recited in enumerated example embodiment 5 wherein the characterizing step further comprises the steps of

identifying the media content portion in relation to the associated information; and

indexing the associated information to the media content portion based on the temporal aspect.

8. The method as recited in enumerated example embodiment 1 wherein the extracting step is performed in real time with respect to the upload or subsequent thereto and prior to run-out time.

9. The method as recited in enumerated example embodiment 1 wherein the media content and the portion thereof comprise at least one or original content or derivative content, and wherein the derivative content is derived from the media content portion with at least one item of content that is independent from an original instance of the media content.

10. The method as recited in enumerated example embodiment 1 wherein the media content and the portion thereof comprise content that is modified with respect to an original instance of the media content; and

wherein the modified content is modified with respect to an original instance of the media content with one or more of editing, scaling or transcoding.

11. The method as recited in enumerated example embodiment 1, further comprising the steps of

comparing the derived media fingerprint with a stored plurality of media fingerprints;

upon the comparing step, matching the derived media fingerprint with one of the stored media fingerprints; and

identifying the media content portion based on the matching step;

wherein at least one of the associating step or the linking step is based on at least one of the matching step or the identifying step.

12. The method as recited in enumerated example embodiment 11 wherein the associated information is presented essentially in real time with respect to the streaming step

13. The method as recited in enumerated example embodiment 1 wherein the media content comprises at least one of video, audio, or image related media content.

14. The method as recited in enumerated example embodiment 1 wherein the associated content comprises at least one of video, audio, textual, graphical, or haptic content.

15. The method as recited in enumerated example embodiment 1 wherein the associated content relates to an advertisement.

16. The method as recited in enumerated example embodiment 1 wherein the associated content comprises at least one of commercial information and instructional information, and wherein the instructional comprises one or more of educational information, aesthetic information, contextual information, analytic information, commentary, or criticism, which relates to the media content portion, or alternative information that relates to the media content portion with at least one of contrast, comparison, augmentation, substantiation, or contradiction.

17. The method as recited in enumerated example embodiment 15 or enumerated example embodiment 16, further comprising the steps of:

providing the associated content; and

in an exchange for the providing step, receiving consideration in remuneration.

18. A system operable in a network for associating content-relatable information with media content, comprising:

means for deriving a media fingerprint from a portion of the media content upon an upload thereof, wherein the media fingerprint comprises a unique representation of the media content portion that is derived from a characteristic component of the media content portion;

means for associating information with the media content portion based on the derived media fingerprint;

means for streaming the media content portion; and

means for linking to the associated information in real time with respect to one or more of the associating or streaming steps;

wherein the associated content is automatically presented in real time with the portion of media content.

19. A computer readable storage medium comprising instructions which, when executed with one or more processors, cause a computer to configure a network operable system for associating content-relatable information with media content, comprising:

means for deriving a media fingerprint from a portion of the media content upon an upload thereof, wherein the media fingerprint comprises a unique representation of the media content portion that is derived from a characteristic component of the media content portion;

means for associating information with the media content portion based on the derived media fingerprint;

means for streaming the media content portion; and

means for linking to the associated information in real time with respect to one or more of the associating or streaming steps;

wherein the associated content is automatically presented in real time with the portion of media content.

20. A computer readable storage medium comprising instructions which, when executed with one or more processors, cause a computer system to perform steps for associating information with media content, wherein the steps include:

upon an upload of a portion of the media content, deriving a media fingerprint from the portion of the media content wherein the media fingerprint comprises a unique representation of the media content portion that is derived from a characteristic component of the media content portion;

associating information with the media content portion based on the derived media fingerprint;

streaming the media content portion; and

linking to the associated information in real time with respect to one or more of the associating or streaming steps;

wherein the associated content is automatically presented in real time with the portion of media content.

### EQUIVALENTS, EXTENSIONS, ALTERNATIVES AND MISCELLANEOUS

Example embodiments for associating information with media content are thus described. In the foregoing specification, embodiments of the present invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for associating information with media content, comprising the steps of:
upon an upload of a portion of the media content, deriving a media fingerprint from the portion of the media content wherein the media fingerprint comprises a unique representation of the media content portion that is derived from a characteristic component of the media content portion;
associating information with the media content portion based on the derived media fingerprint;
streaming the media content portion; and
linking to the associated information in real time with respect to one or more of the associating or streaming steps;
wherein the associated content is automatically presented in real time with the portion of media content.

2. The method as recited in claim 1, further comprising the step of:
storing the uploaded media content portion.

3. The method as recited in claim 2, further comprising the step of characterizing the media content portion;
wherein the characterizing step comprises the steps of:
generating metadata that describes the media content portion; and
storing the metadata in association with the media content portion.

4. The method as recited in claim 3 wherein the characterizing step comprises the step of:
identifying the media content portion in relation to a temporal aspect relating to the media content to which the portion belongs;
wherein the temporal aspect relates to a time period to which the media content portion corresponds within the duration of the media content to which the portion belongs; and
wherein the characterizing step further comprises the steps of:
identifying the media content portion in relation to the associated information; and
indexing the associated information to the media content portion based on the temporal aspect.

5. The method as recited in claim 1 wherein the extracting step is performed in real time with respect to the upload or subsequent thereto and prior to run-out time.

6. The method as recited in claim 1 wherein the media content and the portion thereof comprise at least one or original content or derivative content;
wherein the derivative content is derived from the media content portion with at least one item of content that is independent from an original instance of the media content.

7. The method as recited in claim 1 wherein the media content and the portion thereof comprise content that is modified with respect to an original instance of the media content; and
wherein the modified content is modified with respect to an original instance of the media content with one or more of editing, scaling or transcoding.

8. A system operable in a network for associating content-relatable information with media content, comprising:
means for deriving a media fingerprint from a portion of the media content upon an upload thereof, wherein the media fingerprint comprises a unique representation of the media content portion that is derived from a characteristic component of the media content portion;
means for associating information with the media content portion based on the derived media fingerprint;
means for streaming the media content portion; and
means for linking to the associated information in real time with respect to one or more of the associating or streaming steps;
wherein the associated content is automatically presented in real time with the portion of media content.

9. A computer readable storage medium comprising instructions which, when executed with one or more processors, cause a computer to configure a network operable system for associating content-relatable information with media content, comprising:
means for deriving a media fingerprint from a portion of the media content upon an upload thereof, wherein the media fingerprint comprises a unique representation of the media content portion that is derived from a characteristic component of the media content portion;
means for associating information with the media content portion based on the derived media fingerprint;
means for streaming the media content portion; and
means for linking to the associated information in real time with respect to one or more of the associating or streaming steps;
wherein the associated content is automatically presented in real time with the portion of media content.

10. A computer readable storage medium comprising instructions which, when executed with one or more processors, cause a computer system to perform steps for associating information with media content, wherein the steps include:
upon an upload of a portion of the media content, deriving a media fingerprint from the portion of the media content wherein the media fingerprint comprises a unique representation of the media content portion that is derived from a characteristic component of the media content portion;
associating information with the media content portion based on the derived media fingerprint;
streaming the media content portion; and
linking to the associated information in real time with respect to one or more of the associating or streaming steps;
wherein the associated content is automatically presented in real time with the portion of media content.
